(19) United States
(12) Patent Application Publication
(10) Pub. No.: US 2007/0133657 A1
(43) Pub. Date: Jun. 14, 2007

(54) Water-tight thermometer

(75) Inventor: Chu-Yih Yu, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mesure Technology Co., Ltd.

(21) Appl. No.: 11/301,918

(22) Filed: Dec. 13, 2005

(51) Int. Cl. G01K 7/00

(52) U.S. Cl. 374/163

(57) ABSTRACT

A water-tight thermometer is constituted by a body member and a tip member secured thereto. The body member includes a display portion with a display aperture and a probe portion secured thereto. A thermal sensor mounted on the inside of the tip member is adapted for sensing a thermal contact surface and producing a temperature signal. A display unit disposed in the display portion receives the temperature signal for display of a corresponding temperature reading. And a transparent layer with a protrusion extending from an upper surface thereof at least covers the display unit under the display aperture. In particular, an outer wall of the protrusion is closely engaged with an inner wall of the display aperture.

### BACKGROUND OF THE INVENTION

1. Field of the Invention

The invention relates to the field of thermometers, and more particularly to the field of medical thermometers employing a thermal probe for measurement of a patient's temperature, although it is equally applicable to other temperature measurement fields.

2. Description of the Related Art

Electronic thermometers generally offer a great number of advantages over conventional glass and mercury thermometers for use in the health care field. Among the advantages of electronic thermometers are the elimination of sterilization procedures for glass thermometers, made possible by the use of disposable covers; elimination of the possibility of broken glass if a thermometer is dropped; a digital temperature display to eliminate temperature reading errors; and with proper circuit design and calibration, higher accuracy and resolution is possible with accurate measurement and display of tenths of a degree Fahrenheit being easily attainable.

However, a display aperture is typically formed in a surface of a thermometer's housing and therefore designing a structure to prevent liquids from entering the interior of the electronic thermometer is an important issue. Most water-tight designs used in existing electronic thermometers are realized by fitting or inserting a circuit substrate with a liquid crystal display into the thermometer housing such that a resilient plastic membrane on the circuit substrate is squeezed to closely engaged contact with the display aperture.

The water-tight effect is not easy to control since it depend on Geometric tolerances among the thermometer's housing, the resilient plastic membrane, and the circuit substrate.

### SUMMARY OF THE INVENTION

An exemplary embodiment of the present invention overcomes the above-described problems by providing a water-tight thermometer is constituted by a body member and a tip member secured thereto. The body member includes a display portion with a display aperture and a probe portion secured thereto. The tip member with a thermal contact surface is secured to the probe portion. A thermal sensor is mounted on the inside of the thermal contact surface of the tip member for sensing the temperature of the thermal contact surface and producing a temperature signal. A set of lead wires is coupled to the thermal sensor for transmission of the temperature signal. A display unit is disposed in the display portion and connected to the lead wires to receive the temperature signal for display of a corresponding temperature reading. And a transparent layer with a protrusion extending from an upper surface thereof at least covers the display unit under the display aperture. In particular, an outer wall of the protrusion is closely engaged with an inner wall of the display aperture.

An exemplary embodiment of the present invention overcomes the above-described problems by providing a water-tight thermometer is constituted by a body member and a tip member secured thereto. The body member includes a display portion with a display aperture and a probe portion secured thereto. The tip member with a thermal contact surface is secured to the probe portion. A thermal sensor is mounted on the inside of the thermal contact surface of the tip member for sensing the temperature of the thermal contact surface and producing a temperature signal. A set of lead wires is coupled to the thermal sensor for transmission of the temperature signal. A display unit is disposed in the display portion and connected to the lead wires to receive the temperature signal for display of a corresponding temperature reading. A base plate is adapted for supporting the display unit. And a transparent layer with a protrusion extending from an upper surface thereof at least covers the display unit under the display aperture and a part of the base plate. In particular, an outer wall of the protrusion is closely engaged with an inner wall of the display aperture.

### DESCRIPTION OF THE DRAWINGS

The present invention will be described by way of exemplary embodiments, but not limitations, illustrated in the accompanying drawings in which like references denote similar elements, and in which:

FIG. 1 is a schematic view of a water-tight thermometer according to an exemplary embodiment of the invention; and

FIG. 2 is an exploded perspective view of a water-tight thermometer according to an exemplary embodiment of the invention.

### DETAILED DESCRIPTION OF THE INVENTION

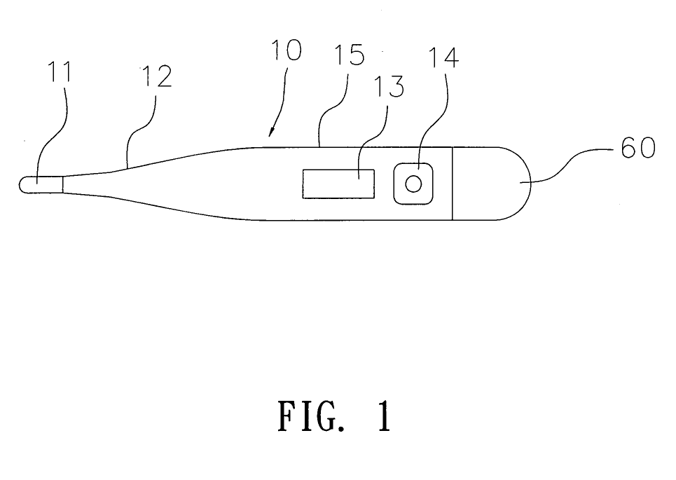

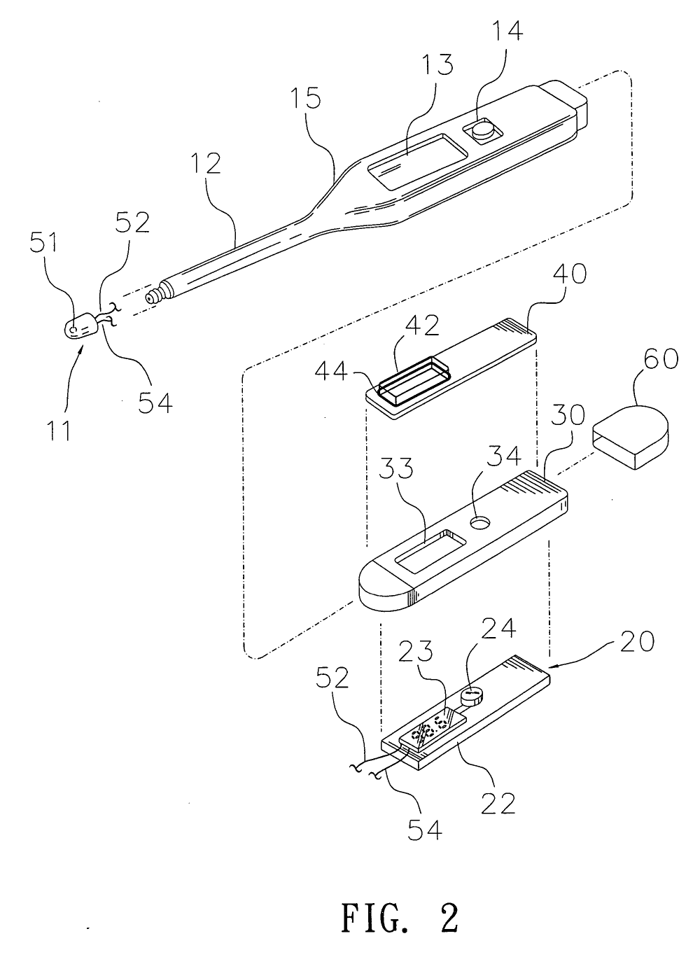

Referring to FIGS. 1 and 2, an embodiment of a thermometer is illustrated. The thermometer is made up of a body member 10 and a tip member 11. Typically, a cover 60 is secured to the body member 10 after components of the thermometer have been assembled. The body member 10 includes a probe portion 12 and a display portion 15. The tip member 11 is secured to the probe portion 12 of the body member 10. Preferably, it contains a thermal contact surface surrounding a hollow cavity. In one embodiment, the hollow tip member 11 is preferably made of metal with good thermal conductivity, such as stainless steel.

A thermal sensor 51 is placed at the end of the tip member 11 and mounted on the inside of the thermal contact surface. The thermal sensor senses the temperature of the thermal contact surface and produces a temperature signal.

There are a set of lead wires 52, 54 coupled to the thermal sensor 51 for transmission of the temperature signal.

A display unit 20 is disposed in the display portion 15 and connected to the lead wires 52, 54 to receive the temperature signal for display of a corresponding temperature reading. Typically, a base plate 30 may be adapted for supporting the display unit 20. In one example, the display unit 20 may comprise a substrate 22; a display 23, such as LCD panel, disposed thereon; and circuit elements (not shown) disposed thereon, coupled to the display 23. The circuit elements are connected to the lead wires 52, 54 to receive the temperature signal; it drives the display 23 to show a corresponding temperature reading. Preferably, the base plate 30 has an opening 33 to expose the display 23. Typically, the base plate 30 is plastic and the substrate 22 is PCB board. The display unit 20 also includes a switch 24 disposed on the substrate 22 to turn on and off the display 23. Furthermore, the switch 24 is controlled by pressing a button 14 formed on the upper surface of the display portion to provide a pressure to the switch 24 through a hole 34 of the base plate 30. Preferably, the button 14 is made of rubber.

In one example, the tip member 11 is made in the form of a tubular shape and closed at a domed, hemispherical or hemiellipsoid shaped end. The contact surface is brought in contact with flesh of a patient so that heat can be transferred from the patient's flesh to the tip member 11. In one embodiment, the thermal sensor 51 is thermistor. The lead wires 52, 54 and the thermistor 51 are both adhered on the inside of the thermal contact surface with heat conductive glue. The glue is an insulating material with good thermal conductivity, e.g., epoxy resin. Moreover, the lead wires 52, 54 are made up of a pair of electrical lead wires; they are used to connect the thermal sensor to the circuitry.

The features of the embodiment will now be described in FIG. 2. A transparent layer 40 with a protrusion 42 extending from an upper surface thereof at least covers the display unit 20 under the display aperture 13. Preferably, the transparent layer 40 covers an entire upper surface of the base plate 30. And generally, the display 23 is disposed on the substrate 22 and under the protrusion 42 of the transparent layer 40.

The transparent layer 40 may be a transparent plastic sheet. Preferably, The transparent layer is made of organic glass or polymethyl methacrylate(PMMA).

According to the embodiment, the protrusion 42 has a peripheral dimension larger than the display aperture 13 before the protrusion 42 is embedded into the display aperture 13, and the outer wall of the protrusion 42 is closely engaged with the inner wall of the display aperture 13 after the protrusion 42 is embedded into the display aperture 13, thereby preventing entry of liquid into the display portion 15 through the display aperture 13.

For enhancing water-tight effect, a sealing member 44 may be mounted overlying the upper surface of the transparent layer 40. It could provide a water-tight seal function after the protrusion 42 is embedded into the display aperture 13 since the sealing member 44 surrounds the protrusion 42 thereby preventing entry of liquid. Preferably, the sealing member 44 is an elastomeric 0-ring.

Therefore, a gap may exist between the transparent layer 40 and the substrate 22 or the base plate 30. And the water-tight effect is easy to control since there is no need to consider Geometric tolerances among the thermometer's housing and the circuit substrate.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A water-tight thermometer comprising:
a body member comprising a display portion with a display aperture, and a probe portion secured to the display portion;
a tip member with a thermal contact surface, secured to the probe portion;
a thermal sensor mounted on the inside of the thermal contact surface of the tip member, for sensing the temperature of the thermal contact surface and producing a temperature signal;
a set of lead wires coupled to the thermal sensor for transmission of the temperature signal;
a display unit disposed in the display portion and connected to the lead wires to receive the temperature signal for display of a corresponding temperature reading; and
a transparent layer with a protrusion extending from an upper surface thereof, at least covering the display unit under the display aperture;
wherein an outer wall of the protrusion is closely engaged with an inner wall of the display aperture.

2. The thermometer as recited in claim 1 wherein the display unit comprises:
a substrate; and
a display under the protrusion of the transparent layer, disposed on the substrate.

3. The thermometer as recited in claim 2 wherein the substrate comprises a PCB board.

4. The thermometer as recited in claim 3 wherein the display unit further comprises a switch disposed on the substrate to turn on and off the display.

5. The thermometer as recited in claim 1 wherein the protrusion has a peripheral dimension larger than the display aperture before the protrusion is embedded into the display aperture, and the outer wall of the protrusion is closely engaged with the inner wall of the display aperture after the protrusion is embedded into the display aperture, thereby preventing entry of liquid into the display portion.

6. The thermometer as recited in claim 5 further comprising a sealing member overlying the upper surface of the transparent layer, surrounding the protrusion for providing a water-tight seal after the protrusion is embedded into the display aperture.

7. The thermometer as recited in claim 6 wherein the sealing member is an elastomeric O-ring.

8. The thermometer as recited in claim 1 wherein the transparent layer is a transparent plastic sheet.

9. The thermometer as recited in claim 1 wherein the transparent layer is made of organic glass or PMMA.

10. A water-tight thermometer comprising:
a body member comprising a display portion with a display aperture, and a probe portion secured to the display portion;
a tip member with a thermal contact surface, secured to the probe portion;
a thermal sensor mounted on the inside of the thermal contact surface of the tip member, for sensing the temperature of the thermal contact surface and producing a temperature signal;
a set of lead wires coupled to the thermal sensor for transmission of the temperature signal;
a display unit disposed in the display portion and connected to the lead wires to receive the temperature signal for display of a corresponding temperature reading;
a base plate supporting the display unit; and
a transparent layer with a protrusion extending from an upper surface thereof, at least covering the display unit under the display aperture and a part of the base plate;
wherein an outer wall of the protrusion is closely engaged with an inner wall of the display aperture.

11. The thermometer as recited in claim 10 wherein the display unit comprises:
a substrate; and
a display under the protrusion of the transparent layer, disposed on the substrate.

12. The thermometer as recited in claim 11 wherein the substrate comprises a PCB board.

13. The thermometer as recited in claim 12 wherein the display unit comprises a switch disposed on the substrate to turn on and off the display.

14. The thermometer as recited in claim 10 wherein the protrusion has a peripheral dimension larger than the display aperture before the protrusion is embedded into the display aperture, and the outer wall of the protrusion is closely engaged with the inner wall of the display aperture after the protrusion is embedded into the display aperture, thereby preventing entry of liquid into the display portion.

15. The thermometer as recited in claim 14 further comprising a sealing member overlying the upper surface of the transparent layer, surrounding the protrusion for. providing a water-tight seal after the protrusion is embedded into the display aperture.

16. The thermometer as recited in claim 15 wherein the sealing member is an elastomeric O-ring.

17. The thermometer as recited in claim 10 wherein the transparent layer is a transparent plastic sheet.

18. The thermometer as recited in claim 10 wherein the transparent layer is made of organic glass or PMMA material.

19. The thermometer as recited in claim 10 wherein the base plate is plastic.
